(19) United States
(12) Patent Application Publication
(10) Pub. No.: US 2015/0359175 A1
(43) Pub. Date: Dec. 17, 2015

(54) Line Trimmer-to-Lawnmower Assembly

(71) Applicant: Carle Klupt, Baltimore, MD (US)

(72) Inventor: Carle Klupt, Baltimore, MD (US)

(73) Assignee: Maryland R and D, LLC, Baltimore, MD (US)

(21) Appl. No.: 14/304,860

(22) Filed: Jun. 13, 2014

(51) Int. Cl. A01D 34/81; A01D 34/416; A01D 34/67; A01D 34/00

(52) U.S. Cl. CPC A01D 34/81; A01D 34/001; A01D 34/416; A01D 34/67; A01D 2101/00

(57) ABSTRACT

Provided herein are means and method to convert a lawn line trimmer into a lightweight and rugged four-wheeled lawn mower of adjustable height to mow grass evenly, which provide further for a hold-down member and forward cam members fixed on the base face to easily lock virtually any line trimmer by its protective shroud onto a base having either a horseshoe shaped cutout opening or a centrally located circular cutout opening, wherein the trimmer's rotating shaft and lines are centered; further provided is a hinged support bar member that further connects the present assembly at the line trimmer handle.

### FIELD OF THE INVENTION

The present invention relates generally to lawn line trimmers and edgers, and in particular to lawn line trimmer supports. More particularly, the present invention relates to support assemblies with wheeled attachments for line trimmers.

### BACKGROUND OF THE INVENTION

The crowded prior art relating to lawn line trimmer adaptors is evidence of the need for an easier way to use a grass line trimmer, as well as the need to adapt such a line trimmer to function as a lawn mower Many property owners with lawns have limited storage space. Most homeowners—and any lawn care provider—would benefit from having a way to quickly and easily convert a grass line trimmer to function as a lawn mower, thereby eliminating the need to buy and store a separate space consuming and expensive lawn mower

The prior art of grass line trimmer supports is replete with devices that attach to grass and weed line trimmers so as to provide for wheeled use of such line trimmers. Wheeled assemblies make it easier for a user to operate a line trimmer since the weight of the line trimmer is supported by a wheel or wheels attached in various and diverse ways to the line trimmer, rather than by the operator Diverse means to accomplish this goal typically provide for only one or two wheels, making it nearly impossible to cut grass evenly or in straight lines.

Assemblies with three or more wheels are also represented in the prior art, but the means of attachment to a line trimmer either require use with only a particular proprietary line trimmer model, require that the protective shroud be removed (as in U.S. Pat. No. 5,287,683), or involve cumbersome assemblies that are time consuming and further susceptible to loosening of the connecting attachments due to the inherent vibrations and shocks of the activated line trimmer assembly in use.

Furthermore, in numerous cases such wheeled attachments provide for swivel wheel mountings that may facilitate grass cutting along a lawn's uneven periphery but thereby teach away from the present invention's means to mow grass in straight rows evenly at whatever grass height an operator chooses.

The limitations in the prior art include: a lack universal adaptability to essentially all commercial grass line trimmers wherein the support structure only works with certain matched proprietary line trimmers; the need to disassemble and remove the protective shroud from the line trimmer; the lack of an assembly form that is both lightweight and rugged and resistant to shocks and vibrations; the inability to enable grass cutting at adjustably uniform heights along straight rows; complicated and time-consuming methods of assembly and use; and relatively expensive to manufacture due to construction with multiple metal parts and hardware.

### SUMMARY OF THE INVENTION

The present inventive line trimmer-to-mower assembly overcomes the limitations and deficiencies of prior art lawn line trimmer supports and adaptors by accomplishing its goals, which include supporting the weight of the line trimmer Further goals and objectives of the present invention are to allow for uniform grass cutting at user-adjustable heights along straight rows; to adaptively accommodate substantially all lawn line trimmers; to retain in this assembly the safeguard of the line trimmer shroud; to be easy to store and clean; to be relatively light-weight yet sturdy; to be designed so that even an unskilled operator can properly assemble the line trimmer-to-mower in about 30 seconds; and, of course, to be inexpensive to manufacture so as to impose minimal financial burden on a buyer

The present invention accomplishes these goals by its functional design that allows cost efficient manufacture with inexpensive materials. More particularly, the present invention accomplishes these goals by having a height-adjustable wheel-mounted base with a reversibly lockable hold-down member and paired forward cam members, as well as a support bar member, which together facilitate a firm connection between the assembly and the line trimmer

By these means the novel line trimmer-to-mower assembly can: be adapted to all line trimmers with protective shrouds; be fitted with a fixed set of non-swiveling wheels to assure straight lines of cutting; comprise a hold down member and paired forward cam members that prevent dislodgement of the line trimmer due to rocks, roots, and debris, as well as guarding against the loosening of screw bolts seen in other such devices resulting from inherent vibrations and operational stresses and strains; be provided with a base further having a cutout opening that captures grass in position for optimal cutting; encompass a telescoping support bar member that allows a user to alter the angle between the handle and a horizontal plane so as to accommodate different terrains and user heights; and, be easily and quickly put together with essentially all line trimmers having shrouds.

### BRIEF DESCRIPTION OF THE DRAWINGS

These and other features, objects and advantages of the present invention will be better understood and become readily apparent to those skilled in the art when consideration is given to the following detailed description, pending claims, and drawings. These three drawings are for illustrative purposes only, to make clear the relationship of the assembly components; the drawings are not drawn to scale and certain proportions and features are exaggerated to clarify the working interaction of the components as delineated in the claims and specification. The following detailed description makes reference to the attached number-labeled drawings wherein:

FIG. 1 is a perspective view of the lawn line trimmer seated in the trimmer-to-mower assembly

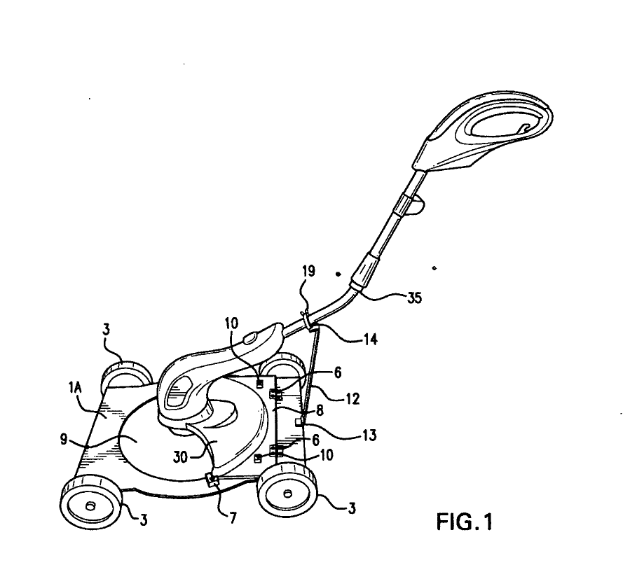

FIG. 2 is a top view of the lawn lint trimmer-to-mower assembly.

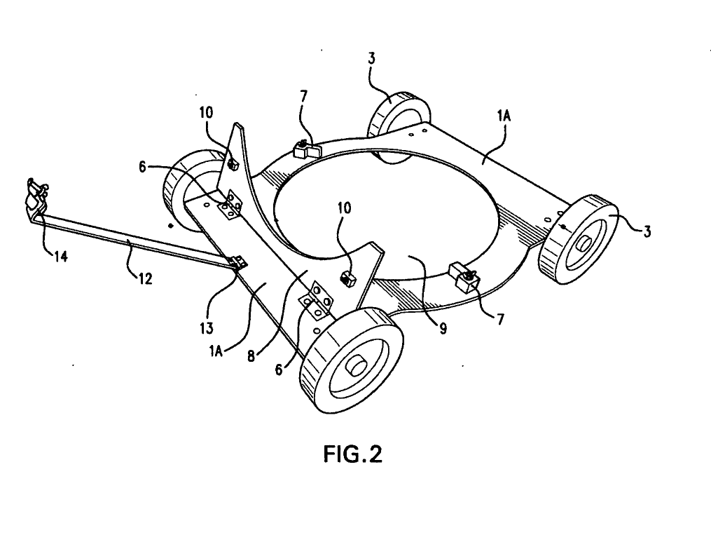

FIG. 3. is a bottom view of the lawn line trimmer-to-mower assembly

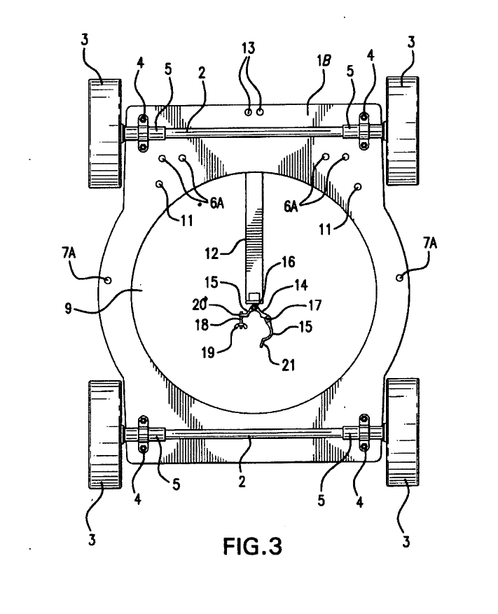

### DETAILED DESCRIPTION OF THE INVENTION

A base (1) is provided in the present invention on which a grass line trimmer is securely connectable. Said base (1) has a top side (1A) and an opposing undercarriage (1B), with mountings for four paired wheels (3) built into the base's undercarriage (1B), preferably at or near the corners. The base (1) is relatively lightweight and rugged, made of materials such as a strong plastic, polycarbonate, or carbon or wood fiber Such materials are further advantageous as most of them are amenable to injection molding, which is the preferred mode of manufacture, or other comparable cost-efficient technique.

The thickness of the base (1), as well as the materials of its composition, are determined so as to resist any twisting or other deformation during use and may encompass strengthening struts formed as part of the base's undercarriage (1B). Within the base (1) there is provided a centrally located circular cutout opening (9) at least sufficient in size and shape—in the range of 13 inches through 24 inches diameter; prototypically about 17 inches diameter—for the trimmer shroud (30) to be seated upon its edge thereby allowing the base (1) to receive the shroud (30) of a grass line trimmer

Line trimmer shrouds (30) have at their free arcuate edge—generally circular—a reinforced edge or rim that is important for providing strength to the shroud and ensuring that it retains its partial bell shape. It is to this shroud rim that the hold down member (8) is fixedly tightened with reversibly locking means (10), and to which the forward cam members (7) are tightened in the process of firmly assembling the line trimmer onto the base of the present invention.

The cutout opening (9) defines a space for the line trimmer rotor and its attached cutting line to extend into and through, being docked in a generally centered position relative to the opening. In a first embodiment the cutout opening (9) is substantially circular in shape. This cutout opening (9) further defines a cutting area of the present inventive line trimmer-to-mower assembly in which the cutting action of the seated trimmer is bounded by the sides of the base around the cutout opening which is further covered in its rear aspect by the trimmer shroud (30).

In an alternative embodiment wherein the cutout opening (9) is formed with an horseshoe shape open to the front, this cutting area encompasses the forward extending arms of the base, the rear aspect of the base, and is further covered by the trimmer shroud. In this second embodiment of the present invention, the base also has a rectilinear back edge but is formed with a forward-placed cut-out that gives the base a U-shape with a pair of opposing forward side edges formed as arms extending frontward from the solid-shaped part of the base. In either embodiment the wheel mountings are located at the front and rear base corners, the wheels (3) being mounted on axles (2) suspended by adjustable mounting means on the base undercarriage (1B).

There is further provided a support bar member (12) that is hingedly attached (13) at a first end to a mid-point of the base (1A), at or close to the base's rear edge. Said support bar member (12) is a relatively rigid and narrow elongated arm made of aluminum, wood, carbon fiber or plastic, easily and reversibly connectable at its second end (14) to the shaft of a line trimmer handle (35).

A line trimmer is attachable to the present line trimmer-to-mower assembly and securable at four locations: along the rear rim of the line trimmer shroud (30) by the hold down member (8), and at both forward edges of the line trimmer shroud by the forward cam members (7), as well as at the reversible joining of the line trimmer handle shaft (35) and the second end of the support bar member (14).

For quick attachment and release of the reversible coupling between the line trimmer handle shaft (35) and the support bar member (12) of the present invention, means are provided that encompass: simple line ties; VELCRO® or similar hook-and-loop material straps; a reversibly ratcheting coupler; a spring-loaded key-in-hole device; a screw-down latch; a pipe strap (14, 15, 16, 17, 18, 19, 20); and any functionally equivalent device and method that reversibly and firmly secures said line trimmer handle shaft with said support bar member of the present invention.

It will be apparent to those skilled in the art, after reading this description, how to implement the present line trimmer-to-mower assembly in diverse but related embodiments. Even though specific embodiments may be described herein, it is to be understood that such embodiments are presented only as examples of the inventive line trimmer-to-mower assembly and not as limitations.

The detailed exemplary embodiment presented herein is a particular illustration of how someone skilled in the art can practice the present invention as set out in the Claims. In no way should this example be construed to impose any limitations on the line trimmer-to-mower assembly as Claimed herein.

A line trimmer is fitted onto the line trimmer-mower adaptor by securing the line trimmer shroud (35) onto the base (1) at three places so that the rotating line of the line trimmer is roughly centered over the circular cutout opening (9) in the base (1), allowing the rotating cutting line to operate in a generally horizontal plane beneath the base. The line trimmer is further secured to the present line trimmer-to-mower assembly along the shaft of the line trimmer handle (35), with a hinged support bar member (12) extending up from the base (1A) and connectable to the mid-section of the line trimmer handle shaft (35).

The line trimmer shroud (30) is firmly held in place on the base (1), in part, through the use of a hinged hold down member (8). The hold down member (8) has three rectilinear sides and a semi-circular forward opening giving it a broad U-shape; the hold down member (8) is hingedly connected (6) to the rear of the base along the hold down member's straight rear edge. The hold down member (8) is reversibly and firmly secured to the base in its forward part with means appropriate to this function, such as two threaded knobs (10) that can be screwed into the corresponding bolts (11) set into the base, thereby locking the hold down member (8) and the intervening line trimmer shroud (30) securely onto the base (1A).

In alternative embodiments, the hold down member (8) may be secured to the base (1A) at the opposite sides of the cutout (9) with: hook and loop material such as VELCRO® strips, ratcheting mechanisms, spring-loaded bolts, and other functionally equivalent methods and means. Furthermore, template members of different patterns and sizes may be included with the line trimmer mower assembly that easily attach to either the hold down member (8) or the base (1) so as to accommodate line trimmer shrouds of different sizes and shapes.

The forward edges of the line trimmer shroud (30) are positioned so as to abut the adjustable forward cam members (7) located on opposite sides along the edge of the base's cutout opening (9). The adjustable forward cam members (7) act to align the line trimmer with the cutout opening (9) of the base (1), further securing the line trimmer shroud firmly to the base (1), and importantly, and to prevent the line trimmer from coming loose from the base at the shroud's forward aspects. Thus the forward cam members (7) may be comprised of a simple rotatable and lockable cam that allow a securingly rearward force to be applied against the shroud rim, or in other embodiments may, by tightening the cam members (7), exert a force not only rearward against the shroud rim but also downward toward the base face plate (1A) so as to lock the interposing shroud rim held between the cam member (7) and the arcuate edge of the cutout opening (9). In other words, the forward cam members (7) can be tightened against the edges of the shroud (30) with a clamping force, by tightening the rotatable forward cam members (7) against the trimmer shroud rim and, additionally, by means which in one embodiment comprise a spring-loaded threaded bolt through the cam member, having a winged and reciprocally threaded nut for tightening the rotated cam member (7) downwardly against the shroud rim. The present invention encompasses all such means that accomplish the equivalent function, namely the reversible tightening of a cam member in a securing and locking position with respect to the shroud rim.

The handle shaft of the line trimmer (35) is reversibly secured to the base (1) through the use of a support bar member (12) that is hingedly fixed at its first end onto the rear aspect of the base (13). The support bar member (12) is a non-flexible, elongated member that affixes at its second end (14) to the handle shaft (35) by means of a pipe clamp type bracket (14) or functionally equivalent securing method. An alternative embodiment encompasses a telescoping support bar member (12) that allows the length of the support bar member to change either during or in preparation for operation.

In one particular embodiment, the means of attachment of the support bar member (12) to the trimmer handle (35) comprises a bracket (14) having two semi-circular halves (15). The two halves of the bracket are hingedly connected to each ether at one end (17). The side opposite the bracket hinge (14) has a bolt (18) and wing nut (9) pinned to the bracket. One half of the bracket is bolted (16) or otherwise securely attached to the support bar member (14). The desired firm connection between line trimmer handle shaft (35) and support bar member (12) is accomplished by placing the line trimmer handle shaft (35) into the half of the bracket (15) attached to the support bar member (14, 16), rotating the unbolted half of the bracket (15) around the line trimmer handle shaft so the two halves of the bracket come together to encircle the line trimmer handle shaft, and tightening the bracket's unhinged ends together with a wing nut (19) and bolt (18) attached at the unhinged bracket end (20); the bolt (18) on the bottom half of the bracket (14) is inserted into the notch (21) on the top unbolted half (15) and the wing nut (9) is tightened to secure the handle shaft (35) to the support bar member (12).

Attached to the undercarriage of the base (1B) are at least two axles (2), upon which paired wheels (3) are mounted. Bushings (5) are provided as part of the mountings, so that the axles and wheels thereon may rotate relatively freely The wheel pairs (3) may be of equal or different diameters, to allow for easier preliminary cutting of high grass or weeds, or in cases when the owner wants to leave the grass taller Larger 4-inch or 5-inch diameter wheels may be preferred in the front of the mower with 3-inch cutting height wheels in the rear so as to put less strain on the line trimmer Alternatively and preferably, the wheels (3) are all a uniform diameter Wheel mountings encompass means to allow a user to adjust the height of the base (1) relative to the ground.

The axles (2) may comprise single rods of equal or different length, situated at the front and rear, each supporting two wheels, or alternatively, may comprise split rods with each split rod holding one wheel. In one embodiment the axles with mounted wheels are attached to the undercarriage (1B) of the base using semi-circular brackets (4), with or without bushings (5), as well as other such brackets, and attached through the use of nut and bolts, screws, civets, or other equivalent fasteners. The axles (2) may be formed as small rods projecting from the sides of the base that are molded, welded, riveted or otherwise formed when the base (1) is created. The wheels (3) may be mounted on the axles (2) using spring-loaded bearings, cotter pins (6), spring clips or other equivalent forms of connections. The axles (2) are mounted onto the undercarriage of the base (1B) through the use of bushings (5), washers (6a) or equivalent mountings that further encompass height adjustment means.

The method of use of the present inventive line trimmer-to-mower assembly comprises seating a line trimmer shroud (30) so the shroud's forward most edges are lodged against the base's adjustable forward cam members (7), and the shroud's rear edge sits along the back edge of the base cutout opening (9). The hold down member (8) is rotated down so as to engage its lock-down means (10) and clamp the shroud between itself and the top of the base (1A). With the line trimmer in position the forward cam members (7) and hold down member lock-down means (10) are tightened so as to secure the shroud (30) to the base (1) at three points, at least. The support bar member (12) is then rotated so as to contact the line trimmer handle (35) and the securing means are tightened to firmly connect the support bar member (12) with the line trimmer handle (35). By such method a line trimmer is mounted firmly to the adjustably-wheeled adaptive assembly allowing the line trimmer cutting line to freely extend through and rotate in the space defined by the base cutout opening (9).

In other words, an operator positions a shroud (30) of said line trimmer at a forward aspect against a pair of forward cam members (7) oppositely located along a curved periphery of a cutout opening (9) of a base (1). The rim of said shroud is seated onto a rear edge of said cutout opening (9) and a hold down member (8) that is hingedly secured (6) to a top face (1A) of a rear aspect of said base (1A) is rotated so that the hold down member (8) overlaps the shroud rim thereby interposing the shroud rim between the hold down member (8) and the base top face (1A). The operator tightens said hold down member (8) with locking means (10) provided thereon and then tightens the forward cam members (7) against the shroud rim. A support bar member (12) that is hingedly secured (13) at a first end to a rear edge of the base top face (1A) is rotated so that the unhinged end of the support bar member can be securely connected to the line trimmer handle shaft (35). Prior to use, an operator may then choose and set a particular cutting height by adjusting the height of the set of wheels (3) mounted on the base undercarriage (1B).

The above description of the disclosed embodiments enables a person skilled in the relevant art to make and use the present invention. Various modifications to the embodiments presented herein will be apparent to such artisans, and the general principles articulated in the description and the claims can be applied to other embodiments without departing from the spirit or the scope of this invention.

Finally, any reference to prior art contained herein is not to be taken as an admission that the information is common general knowledge, unless otherwise indicated.

I claim:

1. A lawn line trimmer-to-mower assembly, comprising:
a base having a top face and a cutout opening, and an undercarriage provided with a set of four wheels mounted thereon; and,
at least two adjustable forward cam members fixedly situated on said top face adjacent to a curved periphery of said cutout opening and that adjustably facilitate an alignment of a shroud of a lawn line trimmer along the curved periphery of the cutout opening; and,
a hold-down member hingedly connected to a rear of the top face and comprising in a forward section an arcuate concavity that is substantially congruent with a curvature of said cutout opening, wherein said hold-down member is rotatably juxtaposable with said top face; and, further comprising:
a support arm hingedly connected at a first end to the rear of the base top face behind said hold-down member, wherein a second end of said support arm further comprises means for a reversible firm attachment to a handle shaft of the lawn line trimmer; wherein,
said set of four wheels comprise at least a pair of wheels that are constrained to a forward and a backward rolling motion so as to prevent a swiveling action by said pair of wheels; and,
means comprising the provided hold-down plate and adjustable forward cam members to firmly connect the lawn line trimmer and the base so as to reversibly clamp the shroud of the lawn line trimmer to the top face of the base along the periphery of the base cutout opening.

2. The lawn line trimmer-to-mower assembly as recited in claim 1, further comprising means to adjustably set a height for said set of wheels.

3. The lawn line trimmer-to-mower assembly as recited in claim 1, wherein said cutout opening has a substantially circular shape.

4. The lawn line trimmer-to-mower assembly as recited in claim 1, wherein said cutout opening has a substantially U-shape, imparting to said base a substantially horseshoe shape.

5. The lawn line trimmer-to-mower convertor assembly as recited in claim 1, wherein said undercarriage is formed with a plurality of strengthening struts.

6. The lawn line trimmer-to-mower assembly as recited in claim 1, wherein the support bar member encompasses a telescoping means to change a length of said support bar member and thereby allow a user to change an angle of the trimmer handle with respect to said base during a use of said assembly.

7. A method of forming an assembly using a line trimmer as a lawn mower comprising the steps of positioning a shroud of said line trimmer at a forward aspect of a base having a set of two paired wheels adjustably mounted on an undercarriage of said base, said positioning of said shroud made against a pair of forward cam members each oppositely located along a curved periphery of a cutout opening of a base; seating a rim of said shroud onto a rear edge of said cutout opening; rotating a hold down member that is hingedly secured to a top face of a rear aspect of said base so that said hold down member overlaps said shroud rim thereby interposing said shroud rim between said hold down member and said top face of said base; tightening said hold down member against said base with a locking means provided on said hold down member and said base and then tightening said pair of forward cam members against said shroud rim; rotating a support bar member that is hingedly secured at a first end to a rear edge of said top face of said base so that a second end of said support bar member is juxtaposed with a handle shaft of said line trimmer; using a securing means provided to firmly secure said support bar member second end to said trimmer handle shaft; and choosing and setting a cutting height for a set of wheels mounted on an undercarriage of said base.

8. The method as recited in claim 7, wherein said adjustably mounted wheels have means for adjusting a height of said wheels, and wherein said support bar member has telescoping means for a changing of the support bar member length prior to and during operation of said assembly.

9. A lawn line trimmer-to-mower assembly comprising,
a adjustably wheeled base with a lawn cutting zone defined by a cutout opening generally centrally located in said base, wherein said cutout opening allows for a rotating shaft and a cutting line of a line trimmer to operatively protrude downward through a central area of said cutout opening, and,
means for reversibly and securely mounting said line trimmer onto said adjustably wheeled base by an attachment to a shroud and a handle of said line trimmer, said means comprising:
a hold-down member hingedly attached to said wheeled base, and
at least two forward cam members attached to said wheeled base along said cutout opening; and
a support bar member hingedly attached to a middle of a rear edge of said base.

10. The lawn line trimmer-to-mower assembly as recited in claim 9, wherein said adjustably wheeled base further comprises at least a pair of front wheels and a pair of rear wheels, and a corresponding set of adjustable wheel mountings that permit a user to alter a height of said paired front wheels and a height of said rear paired wheels.

11. The lawn line trimmer-to-mower assembly as recited in claim 9, wherein said cutout opening comprises a substantially circular form.

12. The lawn line trimmer-to-mower assembly as recited in claim 9, wherein said cutout opening comprises a substantially U-shaped form.

13. The lawn line trimmer-to-mower assembly as recited in claim 9, wherein said support bar member comprises a telescoping assembly that permits a length and a connecting angle of the support bar member to change during a use of the assembly.

14. The lawn line trimmer-to-mower assembly as recited in claim 9, wherein said wheeled base further comprises a top face and an undercarriage, and said undercarriage is formed with a plurality of reinforcing struts.

15. The lawn line trimmer-to-mower assembly as recited in claim 9, wherein said cutout opening has a diameter in a range of 13 inches to 24 inches.
